(19) United States
(12) Patent Application Publication
(10) Pub. No.: US 2006/0294292 A1
(43) Pub. Date: Dec. 28, 2006

(54) Shared spare block for multiple memory file volumes

(76) Inventors: Ajith K. Illendula, Albuquerque, NM (US); Suresh Nagarajan, Mather, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/167,980

(22) Filed: Jun. 27, 2005

(51) Int. Cl. G06F 12/00; G06F 13/00

(52) U.S. Cl. 711/103; 711/159

(57) ABSTRACT

Various embodiments of the invention may share a single spare block among multiple volumes in a memory that has block erase characteristics, such as a flash memory.

### BACKGROUND

Because flash memory can be written to by individual locations, but can only be erased in much larger blocks (e.g., 256 KB blocks), updating a file may require that the file be modified by copying the block containing the file (or at least the block containing the portion of the file that is being modified) from flash memory to volatile memory, modifying the copy in volatile memory, and writing the modified copy to a new spare block of flash memory that was previously empty. Spare blocks are typically maintained in flash memory for just this use. Once the contents of an old block have been copied, modified, and placed into the spare block, the old block may be erased to become a new spare block, to be used in a future file update. Typically, each flash volume may have its own spare block, dedicated for the use of that volume. If the number of volumes in the flash memory is relatively large, and the number of updates is relatively small (or is concentrated in a small number of those volumes), a great deal of flash memory space may be unused and unavailable in the form of spare blocks that are seldom needed.

### BRIEF DESCRIPTION OF THE DRAWINGS

Some embodiments of the invention may be understood by referring to the following description and accompanying drawings that are used to illustrate embodiments of the invention. In the drawings:

FIG. 1 shows an initial configuration of a non-volatile memory, according to an embodiment of the invention.

FIG. 2 shows a flow diagram of a method, according to an embodiment of the invention.

FIG. 3 shows a configuration of the non-volatile memory of FIG. 1 after multiple reclaim operations, according to an embodiment of the invention.

FIG. 4 shows a portion of a system, according to an embodiment of the invention.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure an understanding of this description.

References to “one embodiment”, “an embodiment”, “example embodiment”, “various embodiments”, etc., indicate that the embodiment(s) of the invention so described may include particular features, structures, or characteristics, but not every embodiment necessarily includes the particular features, structures, or characteristics. Further, some embodiments may have some, all, or none of the features described for other embodiments.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements co-operate or interact with each other, but they may or may not be in direct physical or electrical contact.

The term “processor” may refer to any device or portion of a device that processes electronic data from registers and/or memory to transform that electronic data into other electronic data that may be stored in registers and/or memory. A “computing platform” may comprise one or more processors.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

Various embodiments of the invention may be implemented in one or a combination of hardware, firmware, and software. The invention may also be implemented as instructions contained on a machine-readable medium, which may be read and executed by a computing platform to perform the operations described herein. A machine-readable medium may include any mechanism for storing, transmitting, or receiving information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, etc.), the interfaces and/or antennas that transmit and/or receive those signals; and others.

Various embodiments of the invention may share a spare block among multiple volumes, in a non-volatile memory that has block erase characteristics, such as but not limited to flash memory. Block erase characteristics refer to those types of memory whose write characteristics are such that individual bits may not be reset to a defined ‘erased’ state such as all ‘0’s (or all ‘1’s, depending on the convention being used) unless all the bits in a block of memory are reset to that state together. In some types of memory, such as but not limited to flash memory, these blocks may commonly be referred to as ‘erase blocks’.

Within the context of this document, a ‘block’ refers to an ‘erase block’, although the term ‘block’ might be defined elsewhere in other ways for other purposes. Although most of the examples herein refer to one spare block, in some embodiments more than one spare block may each be shared among the same multiple volumes. Within the context of this document, a ‘volume’ may be described as an organizational entity comprised of multiple blocks. However, other terms may be used outside this document to describe such an organizational entity, and the term volume may be used outside this document in other ways. Such differences in terminology should not be read as an artificial limitation on the scope of the appended claims.

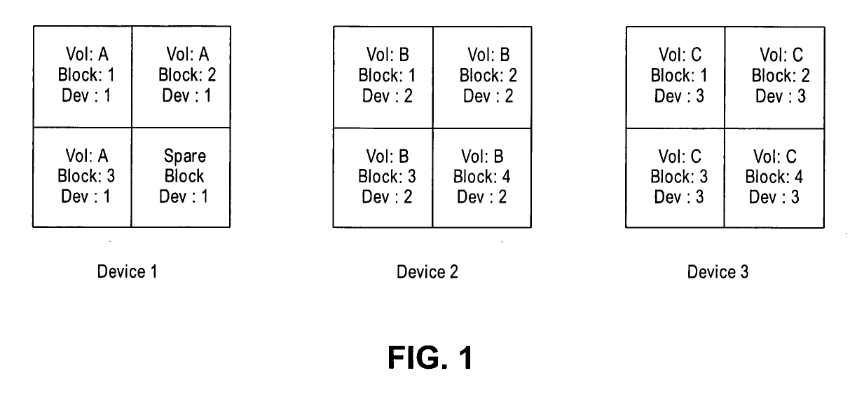

FIG. 1 shows an initial configuration of a non-volatile memory, according to an embodiment of the invention. The illustrated embodiment shows a memory system comprising three devices, labeled devices 1, 2, and 3. Each device may be a separate integrated circuit, although other embodiments may not be limited in this manner (e.g., ‘device’ may be interpreted in a different manner, there may be more or fewer than three devices, etc.). FIG. 1 shows three volumes, designated volumes A, B, and C, although other embodiments may have more or fewer than three volumes. FIG. 1 also shows each volume being initially contained entirely within a separate device, although other embodiments may not be limited in this manner (e.g., a volume may initially be spread across more than one device, and/or multiple volumes may reside within a single device. FIG. 1 also shows each volume comprising either three for four blocks, although other embodiments may contain other numbers of blocks per volume. The spare block is shown in volume 1 and device 1, but other embodiments may initially locate the spare block in any feasible volume and/or device.

The spare block may be used by any of the volumes for a block update process. If more than one volume requests use of the spare block, various priority schemes may be used to resolve which volume will obtain use of the spare block, such as but not limited to: 1) the first request gets to use the spare block, 2) volumes are assigned a priority for this purpose and the higher-ranking volumes wins, 3) update requests are assigned a priority for this purpose and the higher-ranking request wins, 4) etc.

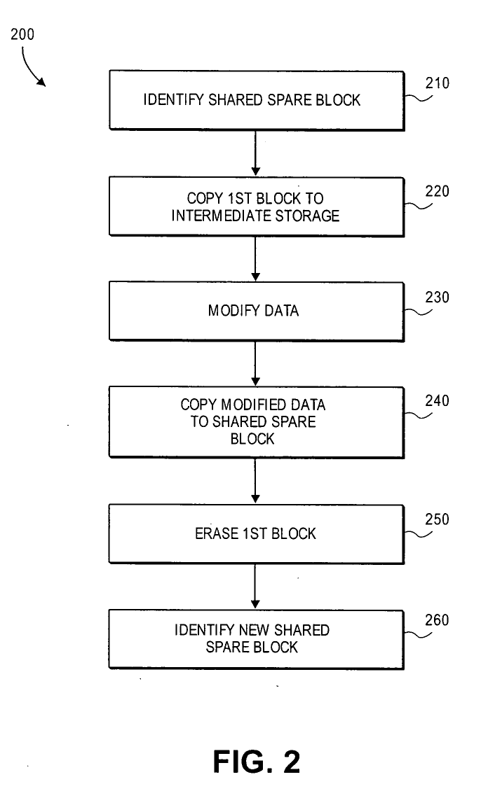

FIG. 2 shows a flow diagram of a method, according to an embodiment of the invention. The method may sometimes be referred to as a ‘reclaim’ operation, although this terminology should not be read as a limitation on various embodiments of the invention. In the illustrated embodiment, the data initially contained in a particular block may be modified in the manner shown and placed in another block. At 210 a spare block may be identified. This identification may take place in any feasible manner, such as but not limited to: 1) scanning some of the contents of each block to find which block is a spare block, 2) keeping track of the spare block in a table in main memory or other feasible location, 3) etc. To facilitate this purpose, in some embodiments each block may contain identification information, such as but not limited to: 1) the volume to which the block belongs, 2) the block number within that volume, 3) the device in which the block resides, 4) the type of block, such as a data block or a spare block, 5) other information as needed.

Once a spare block has been identified, at 220 the contents of a block containing data that is to be changed (called the first block here for ease of identification) may be copied to an intermediate storage area in which the data may be modified without the block erase constraints. Such an intermediate storage area may be any feasible type of storage, such as but not limited to static random access memory (SRAM), dynamic random access memory (DRAM), etc. Such an intermediate storage may be located in any feasible location.

At 230 the data may be modified as needed in intermediate storage, and then the modified data may be written from intermediate storage to the previously-identified spare block at 240. Although in this example all the modification takes place while the data is in intermediate storage, in other embodiments the data may be modified as it is being transferred from the first block to intermediate storage, while it is in intermediate storage, while it is being transferred from intermediate storage to the spared block, or any combination of these. In addition to the modified data, the proper identification information may also be written into the spare block, identifying such things the volume, block number, type of block, etc. Once these operations have been performed, the block previously identified as a spare block may no longer be a spare block, and may no longer be identified as such.

At 250 the first block may be erased, and at 260 the new spare block may be identified. In some embodiments the recently-erased first block may be identified as the new spare block, a technique that may potentially allow all but one block in the non-volatile memory to be available for data at all times. In other embodiments another, previously erased, block may be identified as the new spare block, a technique that may allow the new spare block to be available for use without waiting for the first block to be erased, but which may require at least two blocks to be unavailable for data at any given time.

In some embodiments, operations 220-250 may be controlled partly or entirely by instructions executed by a processor, such as but not limited to those instructions in a software driver.

The update process may create memory blocks in a particular volume that are in different locations than before (e.g., in the location of the previous spare block), and may create new spare blocks that are in different locations than before (e.g., in a location that was previously part of a volume). In the process described above, where a spare block may be used by any of several different volumes, a spare block may eventually reside in any location that was previously occupied by any block of any of those volumes. Similarly, the individual blocks of a volume may eventually reside in any of the locations previously occupied by any of the other volumes. When the volumes collectively occupy multiple devices, both the volumes and the spare block may eventually be randomly arranged throughout the various devices.

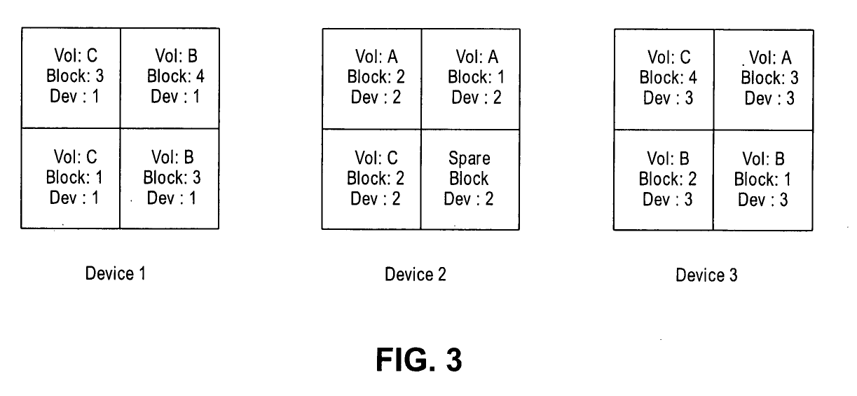

FIG. 3 shows a configuration of the non-volatile memory of FIG. 1 after multiple reclaim operations, according to an embodiment of the invention. As shown, the spare block that was originally in Device 1 is now in Device 2, Blocks 1-3 of Volume A that were originally in Device 1 are now are now in Devices 2 and 3, Blocks 1-4 of Volume B that were originally in Device 2 are now in Devices 1 and 3, and Blocks 1-4 of Volume C are now scattered across Devices 1, 2 and 3. Something must keep track of where the various blocks in a particular volume are located, so that an application program using a particular volume will have unambiguous access to the contents of that volume. In some embodiments this information may be maintained by a table in software, although other embodiments may use different techniques. In some embodiments, each block may contain information that identifies it unambiguously, although other embodiments may use different techniques. For example, in some embodiments each block may contain information such as but not limited to that shown in FIG. 3: 1) the volume to which the information in the block belongs, 2) the block number within that volume, and 3) the device in which the block currently resides. The memory driver software, or other entity, may scan a header or other designated location in each block at the appropriate times to collect this information for all the blocks, and may maintain that information in a convenient place. In some embodiments, this information may be collected at various times, such as but not limited to: 1) after each copy/modify/write process, 2) after each designation of a new spare block, 3) at system start-up, 4) at resume from a low-power state, 5) etc.

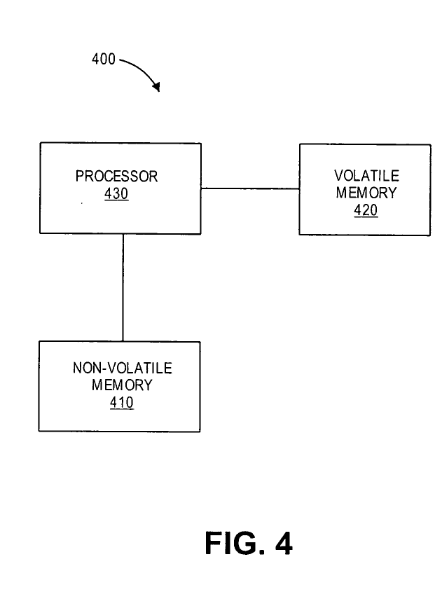

FIG. 4 shows a portion of a computer system, according to an embodiment of the invention. In the illustrated embodiment 400, non-volatile memory 410 may be configured into volumes and blocks in the manner previously described. Processor 430 may obtain instructions for execution, and/or data to operate upon, from volatile memory 420 to control operation of the system. Some of the instructions for execution may be organized as a software driver for the non-volatile memory 410, and the software driver may operate to perform the operations described herein. In other embodiments, these operations may be performed at least partially by a memory controller (not shown), although some embodiments may not use a memory controller for the non-volatile memory.

The foregoing description is intended to be illustrative and not limiting. Variations will occur to those of skill in the art. Those variations are intended to be included in the various embodiments of the invention, which are limited only by the spirit and scope of the following claims.

What is claimed is:

1. An apparatus, comprising:
a computer system including a non-volatile memory having block erase characteristics; the computer system to:
copy data from a first block of the non-volatile memory into intermediate storage;
modify the data in the intermediate storage; and
write the modified data from the intermediate storage to a spare block previously designated to be usable by first and second volumes as a spare block.

2. The apparatus of claim 1, wherein the computer system is further to:
erase the first block; and
designate the first block as a new spare block.

3. The apparatus of claim 1, wherein the computer system is further to recognize more than one block at a time to be useable as spare blocks by the first and second volumes.

4. The apparatus of claim 1, wherein the computer system is further to recognize multiple blocks of the first volume located in at least two devices.

5. The apparatus of claim 1, wherein the computer system is to recognize a first number of blocks in the first volume, and to recognize a second number of blocks, different than the first number, in the second volume.

6. The apparatus of claim 1, wherein the computer system comprises a processor.

7. The apparatus of claim 1, wherein the computer system comprises a volatile memory.

8. A method, comprising:
identifying a first block of a non-volatile memory as a spare block to be shared by first and second volumes in the non-volatile memory;
copying data from a second block in the first volume of the non-volatile memory into intermediate storage;
modifying the data; and
writing the modified data into the first block.

9. The method of claim 8, further comprising:
erasing the second block; and
designating the second block as a new spare block to be shared by the first and second volumes.

10. The method of claim 8, wherein said identifying comprises designating the first block as the spare block.

11. The method of claim 8, further comprising:
writing information into the first block prior to said identifying, the information indicating the first block is the spare block;
wherein said identifying comprises reading said information from the first block.

12. The method of claim 8, wherein said identifying comprises identifying a third blocks of the non-volatile memory as another spare block to be shared by first and second volumes.

13. The method of claim 8, wherein the first and second blocks are located in different devices.

14. An article comprising
a machine-readable medium that provides instructions, which when executed by a computing platform, result in at least one machine performing operations comprising:
identifying a first block of a non-volatile memory as a spare block to be shared by first and second volumes in the non-volatile memory;
copying data from a second block in the first volume of the non-volatile memory into intermediate storage;
modifying the data; and
writing the modified data into the first block.

15. The article of claim 14, wherein the operations further comprise:
erasing the second block; and
designating the second block as a new spare block to be shared by the first and second volumes.

16. The article of claim 14, wherein the operation of identifying comprises designating the first block as the spare block.

17. The article of claim 14, wherein the operations further comprise:
writing information into the first block prior to said identifying, the information indicating the first block is the spare block;
wherein said identifying comprises reading said information from the first block.

18. The article of claim 14, wherein the operation of identifying comprises identifying a third block of the non-volatiles memory as another spare block to be shared by first and second volumes.

19. The article of claim 14, wherein the first and second blocks are located in different devices.
